(19) United States
(12) Patent Application Publication
(10) Pub. No.: US 2025/0225919 A1
(43) Pub. Date: Jul. 10, 2025

(54) DISPLAY DEVICE

(71) Applicant: SAMSUNG DISPLAY CO., LTD., YONGIN-SI (KR)

(72) Inventors: Hyun Sik HWANG, Yongin-si (KR); Gyu Hyeon KIM, Yongin-si (KR); Jeong Hun KIM, Yongin-si (KR); Neung Beom LEE, Yongin-si (KR)

(21) Appl. No.: 18/976,631

(22) Filed: Dec. 11, 2024

(30) Foreign Application Priority Data
Jan. 10, 2024 (KR) 10-2024-0004254

(51) Int. Cl. G09G 3/32; G09G 3/3266

(52) U.S. Cl. CPC G09G 3/32; G09G 3/3266; G09G 2310/0267; G09G 2320/0247; G09G 2330/021

(57) ABSTRACT

A display device including: a pixel unit including first pixel rows connected to first emission lines and second pixel rows connected to second emission lines; an emission driver including first emission stages connected to first emission lines and second emission stages connected to second emission lines; and a scan driver including first scan stages and second scan stages connected to first and second pixel rows, respectively, wherein one first emission stage is connected to a first emission start line, one second emission stage is connected to a second emission start line, each first emission stage, except the first emission stage connected to the first emission start line, is connected to a first emission line of a previous first emission stage, and each second emission stage, except the second emission stage connected to the second emission start line, is connected to a second emission line of a previous second emission stage.

This application claims priority under 35 U.S.C. § 119 to Korean Patent Application No. 10-2024-0004254, filed on Jan. 10, 2024, the disclosure of which is incorporated by reference herein in its entirety.

### 1. Technical Field

The disclosure relates to a display device.

### 2. Description of the Related Art

As information technology advances, the importance of display devices, which serve as the interface between users and information, has become more prominent. Consequently, the use of display devices such as liquid crystal displays (LCDs) and organic light-emitting displays (OLEDs) is on the rise.

When a display device shows a moving image, it is desirable to do so at a high frequency to ensure smooth motion. However, since there is no movement when displaying a still image, it can be shown at a lower frequency. Additionally, displaying at a lower frequency is beneficial for reducing power consumption.

However, a problem arises when the display frequency of the device is switched from high to low frequency, as flicker may become visible due to a change in luminance.

### SUMMARY

Embodiments of the disclosure provide a display device that prevents flicker visibility by separating the light emitting stages for odd-numbered and even-numbered pixel rows.

According to an embodiment of the disclosure, a display device includes: a pixel unit including first pixel rows connected to first emission lines and second pixel rows connected to second emission lines, wherein the second pixel rows alternate with the first pixel rows; an emission driver including first emission stages connected to the first emission lines and second emission stages connected to the second emission lines; and a scan driver including first scan stages connected to the first pixel rows and second scan stages connected to the second pixel rows, wherein one of the first emission stages is connected to a first emission start line, one of the second emission stages is connected to a second emission start line, each of the first emission stages, except the first emission stage connected to the first emission start line, is connected to a first emission line of a previous first emission stage, and each of the second emission stages, except the second emission stage connected to the second emission start line, is connected to a second emission line of a previous second emission stage.

After the emission driver applies an emission control signal having a turn-on level to one emission line among the first emission lines and the second emission lines, the emission driver applies the emission control signal having the turn-on level to other emission lines among the first emission lines and the second emission lines, except the emission line to which the emission control signal having the turn-on level was applied.

The first emission stages are connected to a first emission clock line, the second emission stages are connected to a second emission clock line, and pulses of a first emission clock signal applied to the first emission clock line and pulses of a second emission clock signal applied to the second emission clock line do not overlap each other.

One of the first scan stages is connected to a first scan start line, one of the second scan stages is connected to a second scan start line, each of the first scan stages, except the first scan stage connected to the first scan start line, is connected to a first scan line of a previous first scan stage, and each of the second scan stages, except the second scan stage connected to the second scan start line, is connected to a second scan line of a previous second scan stage.

The first scan stages are connected to a first scan clock line, the second scan stages are connected to a second scan clock line, and pulses of a first scan clock signal applied to the first scan clock line and pulses of a second scan clock signal applied to the second scan clock line do not overlap each other.

The first emission clock signal and the first scan clock signal have the same waveform.

The second emission clock signal and the second scan clock signal have the same waveform.

According to an embodiment of the disclosure, a display device includes: a pixel unit including first pixel rows and second pixel rows alternating with the first pixel rows; an emission driver including first emission stages connected to a first emission line, which is connected to pixels positioned in first pixel columns among the first pixel rows and pixels positioned in second pixel columns among the second pixel rows, and second emission stages connected to a second emission line, which is connected to pixels positioned in the first pixel columns among the second pixel rows and pixels positioned in the second pixel columns among the first pixel rows; and a scan driver connected to the pixel unit, wherein one of the first emission stages is connected to a first emission start line, one of the second emission stages is connected to a second emission start line, each of the first emission stages, except the first emission stage connected to the first emission start line, is connected to a first emission line of a previous first emission stage, and each of the second emission stages, except the second emission stage connected to the second emission start line, is connected to a second emission line of a previous second emission stage.

After the emission driver applies an emission control signal having a turn-on level to one emission line among the first emission lines and the second emission lines, the emission driver applies the emission control signal having the turn-on level to other emission lines among the first emission lines and the second emission lines to which the emission control signal having the turn-on level was applied.

The first emission stages are connected to a first emission clock line, the second emission stages are connected to a second emission clock line, and pulses of a first emission clock signal applied to the first emission clock line and pulses of a second emission clock signal applied to the second emission clock line do not overlap each other.

The scan driver includes first scan stages connected to a first scan line, which is connected to the pixels positioned in the first pixel columns among the first pixel rows and the pixels positioned in the second pixel columns among the second pixel rows, and second scan stages connected to a second scan line, which is connected to the pixels positioned in the first pixel columns among the second pixel rows and the pixels positioned in the second pixel columns among the first pixel rows.

One of the first scan stages is connected to a first scan start line, one of the second scan stages is connected to a second scan start line, each of the first scan stages, except the first scan stage connected to the first scan start line, is connected to a first scan line of a previous first scan stage, and each of the second scan stages, except the second scan stage connected to the second scan start line, is connected to a second scan line of a previous second scan stage.

The first scan stages are connected to a first scan clock line, the second scan stages are connected to a second scan clock line, and pulses of a first scan clock signal applied to the first scan clock line and pulses of a second scan clock signal applied to the second scan clock line do not overlap each other.

The first emission clock signal and the first scan clock signal have the same waveform.

The second emission clock signal and the second scan clock signal have the same waveform.

According to this disclosure, by separating the emission stages for odd-numbered and even-numbered pixel rows, flicker visibility may be prevented, and the power consumption required for high-frequency driving may be reduced.

### BRIEF DESCRIPTION OF THE DRAWINGS

The above and other features of this disclosure will become apparent by describing in detail embodiments thereof with reference to the accompanying drawings, in which:

FIG. 1 is a diagram illustrating a display device according to embodiments of the disclosure;

FIG. 2 is a diagram illustrating a pixel according to an embodiment of the disclosure;

FIG. 3 is a diagram illustrating a method of driving a pixel according to an embodiment of the disclosure;

FIGS. 4, 5, 6 and 7 are diagrams illustrating an emission driver, a pixel unit, and a scan driver according to a first embodiment of the disclosure; and

FIGS. 8 and 9 are diagrams illustrating an emission driver, a pixel unit, and a scan driver according to a second embodiment of the disclosure.

### DETAILED DESCRIPTION OF THE EMBODIMENTS

Hereinafter, various embodiments of this disclosure are described in detail with reference to the attached drawings, enabling those skilled in the art may easily implement the disclosure. The disclosure may be implemented in various forms and is not limited to the embodiments described below.

In the drawings, parts unrelated to the disclosure may be omitted for clarity, and similar parts may be given the same reference numerals throughout the specification.

In addition, terms such as “unit” and “module” used below, or functional blocks shown in the drawings, may be implemented as software configurations, hardware configurations, or a combination of both.

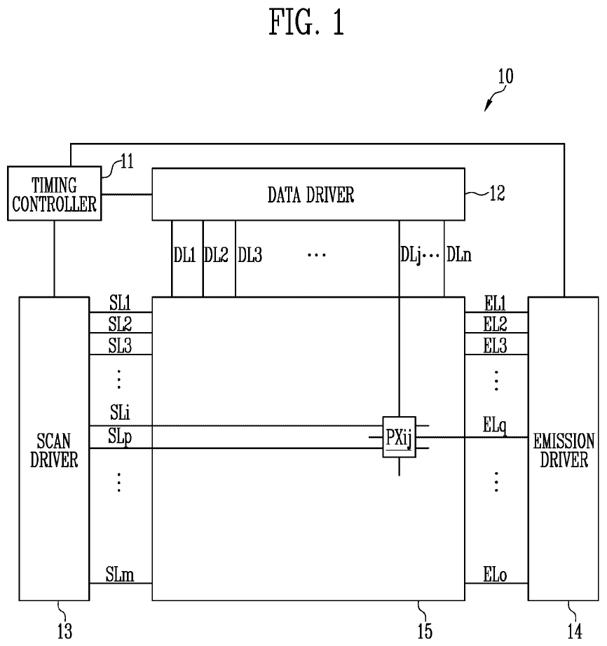

FIG. 1 is a diagram illustrating a display device according to embodiments of the disclosure.

Referring to FIG. 1, the display device 10 according to an embodiment of the disclosure may include a timing controller 11, a data driver 12, a scan driver 13, an emission driver 14, and a pixel unit 15.

The timing controller 11 may receive grayscales and control signals for each image frame from a processor. The timing controller 11 may provide control signals suitable for each specification to the data driver 12, the scan driver 13, the emission driver 14, and other components to display an image corresponding to the image frame.

The timing controller 11 may render the grayscales to correspond to the specification of the pixel unit 15. For example, the processor may provide a red grayscale, a green grayscale, and a blue grayscale for each unit dot.

The data driver 12 may generate data voltages to be provided to data lines DL1, DL2, DL3, DLj, and DLn using the provided grayscales the control signals. The data voltages supplied to the data lines DL1, DL2, DL3, DLj, and DLn may be supplied to a pixel PXij selected by a scan signal. j is an integer greater than 0, and n is an integer greater than j.

The scan driver 13 may receive a clock signal, a scan start signal, and the like from the timing controller 11 and generate scan signals to be provided to scan lines SL1, SL2, SLi, SLp, and SLm. i is an integer greater than 0, p is an integer greater than i, and m is an integer greater than p.

The scan driver 13 may provide the scan signals to the scan lines SL1 to SLm. For example, the scan driver 13 may sequentially supply scan signals with a turn-on pulse level. The scan driver 13 may include scan stages configured in a as a shift register. For example, the scan driver 13 may generate the scan signals by sequentially transmitting the scan start signal in a form of the turn-on pulse to a next scan stage, according to the control of scan clock signals.

The emission driver 14 may provide emission signals to emission lines EL1, EL2, EL3, ELq, and ELo. For example, the emission driver 14 may sequentially supply emission signals having a turn-off pulse level. The emission driver 14 may include emission stages configured as a shift register. For example, the emission driver 14 may generate the emission signals by sequentially transmitting an emission control signal to a next emission stage according to the control of emission clock signals. q is an integer greater than 0, and o is an integer greater than q.

The pixel unit 15 may include a plurality of pixels. Each of the pixels may be connected to at least two of the scan lines SL1 to SLm and at least one of the emission lines EL1 to ELo. In addition, each of the pixels may be connected to at least one of the data lines DL1 to DLn. For example, the pixel PXij may be connected to the i-th scan line SLi, the p-th scan line SLp, the q-th emission line ELq, and the j-th data line DLj. A pixel row may be a set of pixels connected to the same scan lines and emission lines. For example, an i-th pixel row may be pixels connected to the i-th scan line SLi, the p-th scan line SLp, and the q-th emission line ELq. The i-th pixel row includes the pixel PXij. Pixels configuring the i-th pixel row may be connected to different data lines.

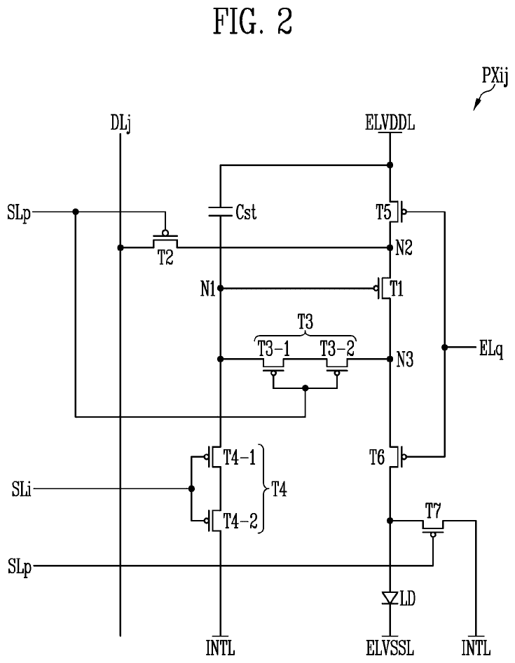

FIG. 2 is a diagram illustrating a pixel according to an embodiment of the disclosure.

Referring to FIG. 2, the pixel PXij includes transistors T1, T2, T3, T4, T5, T6, and T7, a storage capacitor Cst, and a light emitting diode LD.

Hereinafter, a circuit configured with a P-type transistor is described as an example. However, those skilled in the art can design a circuit using an N-type transistor by adjusting the polarity of a voltage applied to the gate terminal. Similarly, those skilled in the art can design a circuit using a combination of a P-type transistor and an N-type transistor. The P-type transistor refers to a transistor where the current increases as the voltage difference between the gate electrode and the source electrode increases in a negative direction. The N-type transistor refers to a transistor where the current increases as the voltage difference between a gate electrode and a source electrode increases in a positive direction. The transistor may be configured in various forms such as a thin film transistor (TFT), a field effect transistor (FET), and a bipolar junction transistor (BJT).

The transistor T1 may have a gate electrode connected to a node N1, a first electrode connected to a node N2, and a second electrode connected to a node N3. The transistor T1 may be a driving transistor.

The transistor T2 may have a gate electrode connected to the p-th scan line SLp, a first electrode connected to the j-th data line DLj, and a second electrode connected to the node N2. The transistor T2 may be a scan transistor.

The transistor T3 may have a gate electrode connected to the p-th scan line SLp, a first electrode connected to the node N1, and a second electrode connected to the node N3. The transistor T3 may be a diode connection transistor. In an embodiment, the transistor T3 may be configured so that two sub-transistors are connected in series and controlled by a single signal. For example, the transistor T3 may be configured so that a first sub-transistor T3-1 and a second sub-transistor T3-2 are connected in series and controlled by a signal applied from the p-th scan line SLp.

The transistor T4 may have a gate electrode connected to the i-th scan line SLi, a first electrode connected to the node N1, and a second electrode connected to an initialization line INTL. In another embodiment, the gate electrode of transistor T4 may be connected to another scan line. The fourth transistor T4 may be a gate initialization transistor.

In an embodiment, the transistor T4 may be configured so that two sub-transistors are connected in series and controlled by a single signal. For example, the transistor T4 may be configured so that a first sub-transistor T4-1 and a second sub-transistor T4-2 are connected in series and controlled by a signal applied from the i-th scan line SLi.

The transistor T5 may have a gate electrode connected to the q-th emission line Elq, a first electrode connected to a first display power line ELVDDL, and a second electrode connected to the node N2. The transistor T5 may be a first emission transistor. In another embodiment, the gate electrode of the transistor T5 may be connected to another emission line.

The transistor T6 may have a gate electrode connected to q-th emission line ELq, a first electrode connected to the node N3, and a second electrode connected to an anode of the light emitting diode LD. The transistor T6 may be a second emission transistor. In another embodiment, the gate electrode of the transistor T6 may be connected to another emission line.

The transistor T7 may have a gate electrode connected to the p-th scan line SLp, a first electrode connected to the initialization line INTL, and a second electrode connected to the anode of the light emitting diode LD. The transistor T7 may be an anode initialization transistor. In another embodiment, the gate electrode of transistor T7 may be connected to another scan line.

A first electrode of the storage capacitor Cst may be connected to the first display power line ELVDDL and a second electrode may be connected to the node N1.

The anode of the light emitting diode LD may be connected to the second electrode of the transistor T6 and a cathode of the light emitting diode LD may be connected to a second display power line ELVSSL. The light emitting diode LD may be configured of an organic light emitting diode, an inorganic light emitting diode, a quantum dot/well light emitting diode, or the like.

The first display power line ELVDDL may be supplied with a first power voltage, the second display power line ELVSSL may be supplied with a second power voltage, and the initialization line INTL may be supplied with an initialization voltage.

For example, during a display period of the display device 10, the first power voltage may be greater than the second power voltage. For example, the initialization voltage may be equal to or greater than the second power voltage. For example, the initialization voltage may correspond to the smallest data voltage that can be provided. For example, the magnitude of the initialization voltage may be less than the magnitude of the data voltages that can be provided.

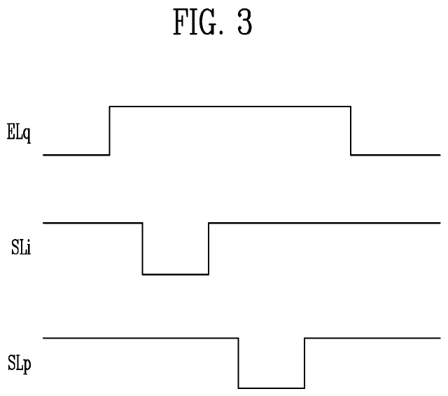

FIG. 3 is a diagram illustrating a method of driving a pixel according to an embodiment of the disclosure.

Referring to FIG. 3, the driving method is described based on the pixel PXij described above with reference to FIG. 2. In addition, the pixels of the i-th pixel row are driven using the same method as shown in FIG. 3.

First, a turn-on level (logic low level) of i-th scan signal may be applied to the i-th scan line SLi. At this time, since a turn-off level (logic high level) of scan signal is applied to the p-th scan line SLp, the transistor T2 is turned-off, and a data voltage for another pixel is prevented from entering to the pixel PXij.

At this time, since the transistor T4 is turned-on, the first node N1 is connected to the initialization line INTL, and a voltage of the first node N1 is initialized. Since a turn-off level of emission signal is applied to the emission line Ei, the transistors T5 and T6 are turned-off, and unnecessary light emission of the light emitting diode LD due to an initialization voltage application process is prevented.

Next, a data voltage for the pixel PXij is applied to the data line DLj, and the turn-on level of scan signal is applied to the p-th scan line SLp. Accordingly, the transistors T2, T1, and T3 are turned on, and the data line DLj and the first node N1 are electrically connected to each other. Therefore, a compensation voltage, which is obtained by subtracting a threshold voltage of the transistor T1 from the data voltage, is applied to a second electrode of the storage capacitor Cst (e.g., the first node N1). The storage capacitor Cst maintains a voltage corresponding to a difference between the first display power voltage and the compensation voltage. This period may be referred to as a threshold voltage compensation period.

At this time, since the seventh transistor T7 is turned-on, the anode of the light emitting diode LD and the initialization line INTL are connected to each other. The light emitting diode LD is initialized to a charge amount corresponding to a voltage difference between the initialization voltage and the second display power voltage.

Thereafter, as the turn-on level of emission signal is applied to the q-th emission line ELq, the transistors T5 and T6 may be turned on. Therefore, a driving current path is formed through the first display power line ELVDDL, the transistor T5, the transistor T1, the transistor T6, the light emitting diode LD, and the second display power line ELVSSL.

The amount of driving current flowing between the first electrode and the second electrode of the transistor T1 is adjusted according to the voltage maintained in the storage capacitor Cst. The light emitting diode LD emits light with a luminance corresponding to the driving current amount. The light emitting diode LD continues to emit light until the turn-off level of emission signal is applied to the emission line ELq.

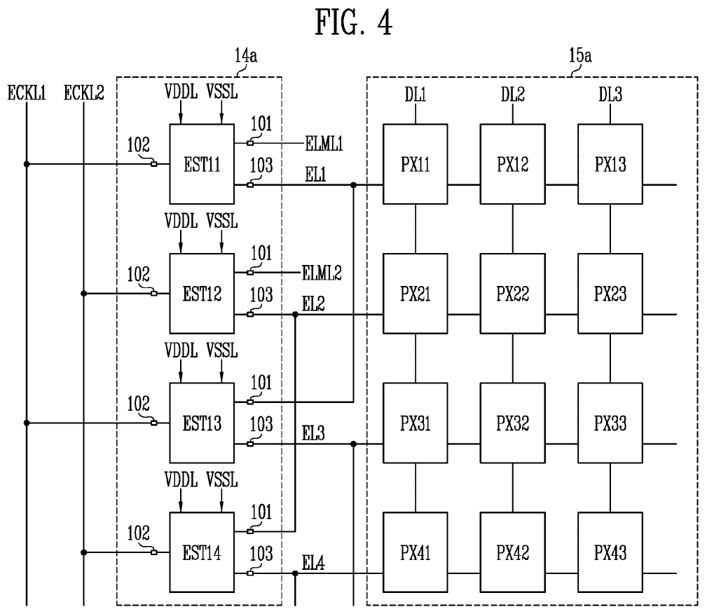

FIGS. 4 to 7 are diagrams illustrating an emission driver, a pixel unit, and a scan driver according to a first embodiment of the disclosure.

Referring to FIG. 4, a connection relationship between the emission driver 14a and the pixel unit 15a according to the first embodiment is shown. FIG. 4 shows four emission stages EST11 to EST14 for convenience of description.

The emission driver 14a may include first emission stages EST11, EST13, . . . connected to first emission lines EL1, EL3, . . . , and second emission stages EST12, EST14, . . . connected to second emission lines EL2, EL4, . . .

The pixel unit 15a may include first pixel rows connected to the first emission lines EL1, EL3, . . . , and second pixel rows alternating with the first pixel rows and connected to the second emission lines EL2, EL4, . . .

The first emission lines EL1, EL3, . . . may be connected to the first pixel rows. For example, the first pixel rows may be odd-numbered pixel rows. For example, the first emission lines EL1, EL3, . . . may be odd-numbered emission lines. For example, the first emission stages EST11, EST13, . . . may be odd-numbered scan stages.

The second emission lines EL2, EL4, . . . may be connected to the second pixel rows. For example, the second pixel rows may be even-numbered pixel rows. For example, the second emission lines EL2, EL4, . . . may be even-numbered emission lines. For example, the second emission stages EST12, EST14, . . . may be even-numbered scan stages.

Each of the emission stages EST11 to EST14 may include a first input terminal 101, a second input terminal 102, and an output terminal 103.

The first input terminal 101 of one EST11 of the first emission stages EST11, EST13, . . . may be connected to a first emission control line ELML1.

The first input terminal 101 of one EST12 of the second emission stages EST12, EST14, . . . may be connected to a second emission control line ELML2. The output terminal 103 of the first emission stage EST11 may be connected to the first emission line EL1, and the output terminal 103 of the second emission stage EST12 may be connected to the second emission line EL2.

Each of the first emission stages EST13, . . . except for the first emission stage EST11 may be connected to a first emission line of a previous first emission stage. Each of the second emission stages EST14, . . . except for the second emission stage EST12 may be connected to a second emission line of a previous second emission stage.

For example, the first input terminal 101 of the first emission stage EST13 may be connected to the first emission line EL1 of the first emission stage EST11. For example, the first input terminal 101 of the first emission stage EST13 may be connected to the output terminal 103 of the first emission stage EST11. The first input terminal 101 of the second emission stage EST14 may be connected to the second emission line EL2 of the second emission stage EST12. For example, the first input terminal 101 of the second emission stage EST14 may be connected to the output terminal 103 of the second emission stage EST12.

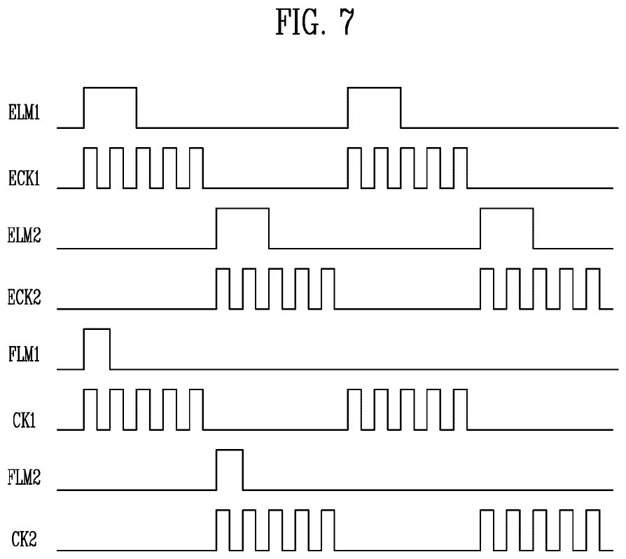

The second input terminal 102 of the first emission stages EST11, EST13, . . . may be connected to a first emission clock line ECKL1. The second input terminal 102 of the second emission stages EST12, EST14, . . . may be connected to a second emission clock line ECKL2. Pulses of a first emission clock signal ECK1 applied to the first emission clock line ECKL1 and pulses of a second emission clock signal ECK2 applied to the second emission clock line ECKL2 do not overlap each other in time (refer to FIG. 7).

The emission stages EST11 to EST14 may be connected to the first emission power line VDDL and the second emission power line VSSL. A voltage level of the emission signal may be set based on a voltage of either the first emission power line VDDL or the second emission power line VSSL.

In an embodiment, after the emission driver 14a applies a turn-on level of the emission control signal to one of the first emission lines EL1, EL3, . . . and the second emission lines EL2, EL4, . . . , the emission driver 14a may then apply the turn-on level of the emission control signal to the emission lines other than those to which the turn-on level of the emission control signal is currently applied.

For example, after the emission driver 14a applies the turn-on level of the emission control signal to the first emission lines EL1, EL3, . . . , the emission driver 14a may apply the turn-on level of the emission control signal to the second emission lines EL2, EL4, . . . . In addition, after the emission driver 14a applies the turn-on level of the emission control signal to the second emission lines EL2, EL4, . . . , the emission driver 14a may apply the turn-on level of the emission control signal to the first emission lines EL1, EL3, . . .

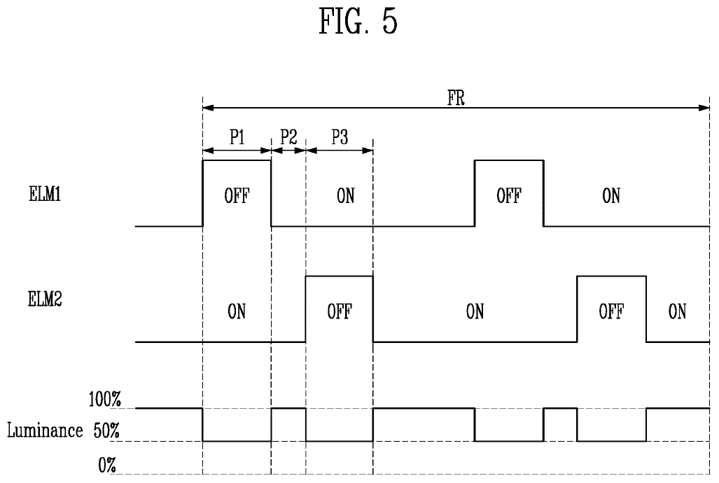

Referring to FIGS. 4 and 5, a method of driving the first emission stage EST11 and the second emission stage EST12 is described.

FIG. 5 shows a first emission control signal ELM1 applied to the first emission control line ELML1 and a second emission control signal ELM2 applied to the second emission control line ELML2 during one frame period FR.

During one frame period FR, the first emission control signal ELM1 defines non-emission periods corresponding to a turn-off level (high level) and emission periods corresponding to a turn-on level (low level). For example, a successive non-emission period and emission period may form one emission cycle. The first emission control signal ELM1 may have two emission cycles during one frame period FR. Similarly, the second emission control signal ELM2 may also have two emission cycles during one frame period FR.

A pulse of the turn-off level (high level) of the first emission control signal ELM1 supplied to the first input terminal 101 of the first emission stage EST11 may not overlap with a pulse of the turn-off level (high level) of the second emission control signal ELM2 supplied to the first input terminal 101 of the second emission stage EST12.

Referring to a first period P1, the first emission control signal ELM1 may have the turn-off level (high level), and the second emission control signal ELM2 may have the turn-on level (low level). Accordingly, the first pixel rows connected to the first emission stages EST11, EST13, . . . may not emit light, and the second pixel rows connected to the second emission stages EST12, EST14, . . . may emit light. When the luminance is set to 100% for the case where all pixels included in the display device emit light and 0% for the case where all pixels included in the display device do not emit light, the display device may have a luminance of 50% during the first period P1 since only the second pixel rows emit light during this time.

Referring to a second period P2, the first emission control signal ELM1 and the second emission control signal ELM2 may have a turn-on level. Accordingly, the first pixel rows connected to the first emission stages EST11, EST13, . . . may emit light, and the second pixel rows connected to the second emission stages EST12, EST14, . . . may emit light. Since the first and second pixel rows emit light during the second period P2, the display device may have a luminance of 100%.

Referring to a third period P3, the first emission control signal ELM1 may have the turn-on level, and the second emission control signal ELM2 may have the turn-off level. Accordingly, the first pixel rows connected to the first emission stages EST11, EST13, . . . may emit light, and the second pixel rows connected to the second emission stages EST12, EST14, . . . may not emit light. During the third period P3, since only the first pixel rows emit light, the display device may have a luminance of 50%.

Based on the first emission control signal ELM1 and the second emission control signal ELM2, the first pixel rows and the second pixel rows can be independently controlled. Accordingly, the luminance of the display device does not abruptly change from 100% to 0%. Instead, the luminance changes gradually, such as from 100% to 50%, and from 50% to 100%, preventing flicker visibility due to differences in the luminance waveform.

In addition, the first pixel rows, controlled by the first emission control signal ELM1, and the second pixel rows, controlled by the second emission control signal ELM2, are positioned adjacent to each other. When the first pixel rows reach their highest luminance and the second pixel rows reach their highest luminance at alternating times, a user may recognize that an emission control signal with four emission cycles is applied to the pixel rows during one frame period FR. Accordingly, the emission control signal having four emission cycles can be achieved through the combination of the first and second emission control signals ELM1 and ELM2 having two emission cycles. This reduces the power consumed for high frequency driving.

However, the disclosure is not limited to the waveform shown in FIG. 5, and the turn-off level of pulse of the first emission control signal ELM1 may overlap with the turn-off level of pulse of the second emission control signal ELM2. In addition, a width of the turn-off level of pulse of the first emission control signal ELM1 may be different from a width of the turn-off level of pulse of the second emission control signal ELM2. In other words, the width of the turn-off level of pulse of the first emission control signal ELM1 and the width of the turn-off level of pulse of the second emission control signal ELM2 may be set to control the period in which the luminance of the display device changes from 50% to 0% or from 0% to 50%.

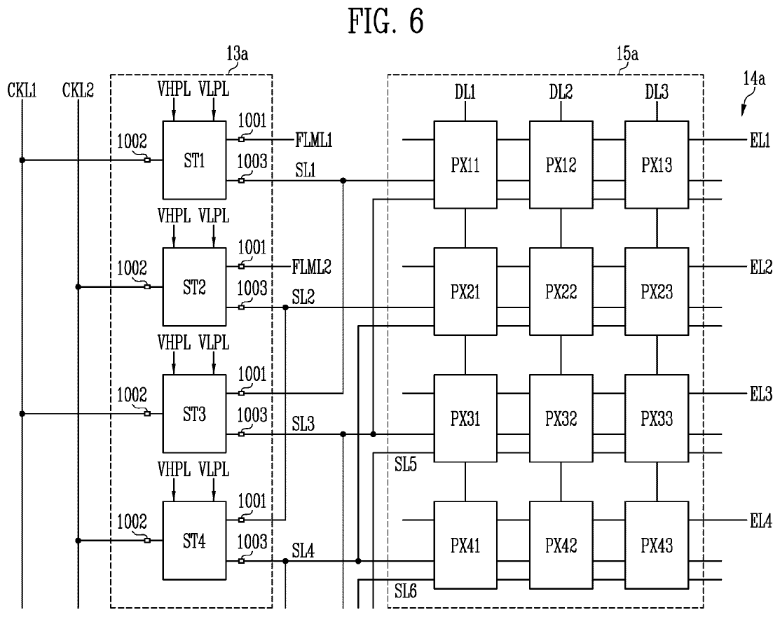

Referring to FIG. 6, the connection relationship between the scan driver 13a and the pixel unit 15a according to the first embodiment is shown. FIG. 6 shows four scan stages ST1 to ST4 for convenience of description.

The scan driver 13a may include first scan stages ST1, ST3, . . . connected to the first scan lines SL1, SL3, . . . , and second scan stages ST2, ST4, . . . connected to second scan lines SL2, SL4, . . .

The pixel unit 15a may include first pixel rows connected to the first scan lines SL1, SL3, . . . , and second pixel rows alternating with the first pixel rows and connected to the second scan lines SL2, SL4, . . . . For example, the one of the first pixel rows (PX11-PX31) may be connected to both of the first scan lines SL1 and SL3. As another example, one of the second pixel rows (PX31-PX33) may be connected to both second scan lines SL3 and SL5.

The first scan lines SL1, SL3, . . . may be connected to the first pixel rows. For example, the first pixel rows may be odd-numbered pixel rows. For example, the first scan lines SL1, SL3, . . . may be odd-numbered scan lines. For example, the first scan stages ST1, ST3, . . . may be odd-numbered scan stages.

The second scan lines SL2, SL4, . . . may be connected to the second pixel rows. For example, the second pixel rows may be even-numbered pixel rows. For example, the second scan lines SL2, SL4, . . . may be even-numbered scan lines. For example, the second scan stages ST2, ST4, . . . may be even-numbered scan stages.

Each of the scan stages ST1 to ST4 may include a first input terminal 1001, a second input terminal 1002, and an output terminal 1003.

The first input terminal 1001 of one first scan stage ST1 of the first scan stages ST1, ST3, . . . may be connected to a first scan start line FLML1. The first input terminal 1001 of one second scan stage ST2 of the second scan stages ST2, ST4, . . . may be connected to a second scan start line FLML2. The output terminal 1003 of the first scan stage ST1 may be connected to the first scan line SL1, and the output terminal 1003 of the second scan stage ST2 may be connected to the second scan line SL2.

Each of the first scan stages ST3, . . . except for the first scan stage ST1 may be connected to a first scan line of a previous first scan stage. Each of the second scan stages ST4, . . . except for the second scan stage ST2 may be connected to a second scan line of a previous second scan stage. For example, the first input terminal 1001 of the first scan stage ST3 may be connected to the first scan line SL1 of the first scan stage ST1. In other words, the first input terminal 1001 of the first scan stage ST3 may be connected to the output terminal 1003 of the first scan stage ST1. In addition, the first input terminal 1001 of the second scan stage ST4 may be connected to the second scan line SL2 of the second scan stage ST2. In other words, the first input terminal 1001 of the second scan stage ST4 may be connected to the output terminal 1003 of the second scan stage ST2.

The second input terminal 1002 of the first scan stages ST1, ST3, . . . may be connected to a first scan clock line CKL1. The second input terminal 1002 of the second scan stages ST2, ST4, . . . may be connected to a second scan clock line CKL2. Pulses of a first scan clock signal CK1 applied to the first scan clock line CKL1 and pulses of a second scan clock signal CK2 applied to the second scan clock line CKL2 do not overlap each other in time (refer to FIG. 7).

Each of the scan stages ST1 to ST4 may be connected to a first scan power line VHPL and a second scan power line VLPL. Here, a voltage of the first scan power line VHPL may be set to a turn-off level (gate-off voltage, logic high level). In addition, a voltage of the second scan power line VLPL may be set to a turn-on level (gate-on voltage, logic low level).

The pixel unit 15a may be connected to the emission driver 14a. For example, first pixel rows PX11, PX12, PX13, . . . may be connected to the first emission line EL1, and second pixel rows PX21, PX22, PX23, . . . may be connected to the second emission line EL2. Since the emission driver 14a is similar to the emission driver 14a of FIG. 4, a detailed description thereof is omitted.

Referring to FIGS. 4, 6, and 7, a method of driving the scan driver 13a, the emission driver 14a, and the pixel unit 15a is described.

FIG. 7 shows a signal applied to the scan driver 13a and the emission driver 14a during one frame period.

The first emission control signal ELM1 may be supplied to the first input terminal 101 of the first emission stage EST11. The first emission clock signal ECK1 may be supplied to the second input terminal 102 of the first emission stages EST11, EST13, . . .

The second emission control signal ELM2 may be supplied to the first input terminal 101 of the second emission stage EST12. The second emission clock signal ECK2 may be supplied to the second input terminal 102 of the second emission stages EST12, EST14, . . .

Pulses of the first emission clock signal ECK1 and pulses of the second emission clock signal ECK2 do not overlap each other in time. In an embodiment, an emission operation of the pixels connected to the first emission lines EL1, EL3, . . . and an emission operation of the pixels connected to the second emission lines EL2, EL4, . . . may be alternately performed.

The first scan start signal FLM1 may be supplied to the first input terminal 1001 of the first scan stage ST1. The first scan clock signal CK1 may be supplied to the second input terminal 1002 of the first scan stages ST1, ST3, . . .

The second scan start signal FLM2 may be supplied to the first input terminal 1001 of the second scan stage ST2. The second scan clock signal CK2 may be supplied to the second input terminal 1002 of the second scan stages ST2, ST4, . . .

Pulses of the first scan clock signal CK1 and pulses of the second scan clock signal CK2 do not overlap each other in time. In an embodiment, a scan operation of the pixels connected to the first scan lines SL1, SL3, . . . and a scan operation of the pixels connected to the second scan lines SL2, SL4, . . . may be alternately performed.

The first scan clock signal CK1 and the first emission clock signal ECK1 may have the same pulse waveform. Accordingly, the scan operation and the emission operation of the first pixel rows may be synchronized.

The second scan clock signal CK2 and the second emission clock signal ECK2 may have the same pulse waveform. Accordingly, the scan operation and the emission operation of the second pixel rows may be synchronized.

In an embodiment, the scan operation and the emission operation may be performed on the odd-numbered pixel rows, and the scan operation and the emission operation may be performed on the even-numbered pixel rows.

In another example, the pixel unit 15a may be divided into two or more areas, and the scan and emission operations may be sequentially performed on the areas. For example, when an upper half of the pixel unit 15a is designated as a first area and a lower half of the pixel unit 15a is designated as a second area, the scan and emission operations may first be performed on the odd-numbered pixel rows of the first area, followed by the even-numbered pixel rows of the first area. Thereafter, the scan and emission operations may be performed on the odd-numbered pixel rows of the second area, followed by the even-numbered pixel rows of the second area.

However, the disclosure is not limited to the waveform shown in FIG. 7 and may be changed according to an internal structure of each of the emission stages and scan stages, as long as the scan operation and the emission operation of each of the pixel rows are synchronized.

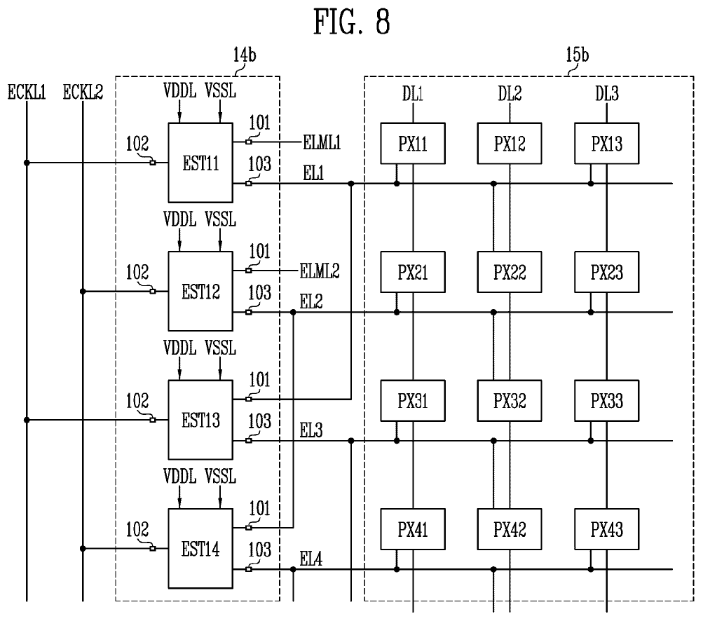

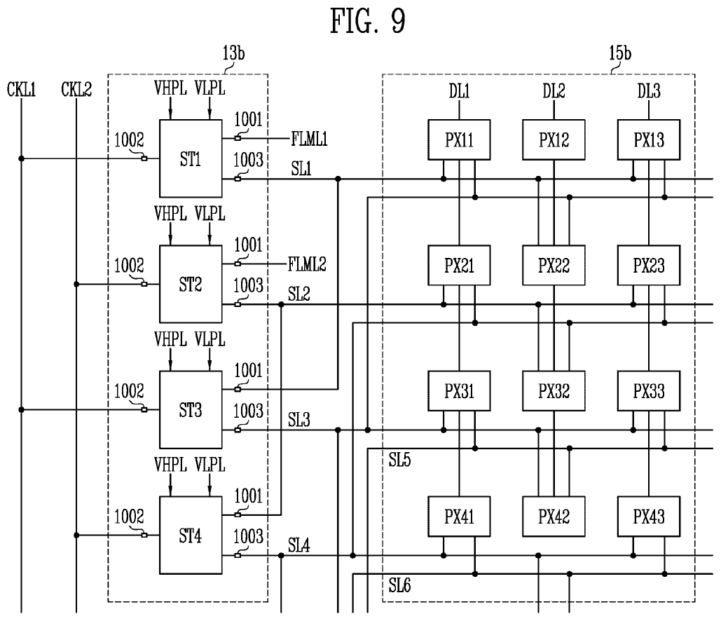

FIGS. 8 and 9 are diagrams illustrating an emission driver, a pixel unit, and a scan driver according to a second embodiment of the disclosure.

Referring to FIG. 8, a connection relationship between the emission driver 14b and the pixel unit 15b according to the second embodiment is shown. FIG. 8 shows four emission stages EST11 to EST14 for convenience of description. In addition, since the emission driver 14b and the pixel unit 15b of FIG. 8 are similar to the emission driver 14a and the pixel unit 15a of FIG. 4, an overlapping description is omitted.

The emission driver 14b may include first emission stages EST11, EST13, . . . connected to the first emission lines EL1, EL3, . . . , and second emission stages EST12, EST14, . . . connected to the second emission lines EL2, EL4, . . .

For example, the first emission stages EST11, EST13, . . . may be odd-numbered scan stages. The second emission stages EST12, EST14, . . . may be even-numbered scan stages.

The first emission lines EL1, EL3, . . . may be connected to pixels positioned in first pixel columns among the first pixel rows of the pixel unit 15b and pixels positioned in second pixel columns among the second pixel rows of the pixel unit 15b. The second emission lines EL2, EL4, . . . may be connected to pixels positioned in first pixel columns among the second pixel rows of the pixel unit 15b and pixels positioned in second pixel columns among the first pixel rows of the pixel unit 15b.

In an embodiment, the first pixel rows may be odd-numbered pixel rows, the second pixel rows may be even-numbered pixel rows, the first pixel columns may be odd-numbered pixel columns, and the second pixel columns may be odd-numbered pixel columns. For example, the first emission line EL1 may be connected to a first pixel PX11 and a third pixel PX13 of a first pixel row and a second pixel PX22 of a second pixel row. The second emission line EL2 may be connected to a first pixel PX21 and a third pixel PX23 of a second pixel row and a second pixel PX32 of a third pixel row.

Referring to FIGS. 7 and 8, the first emission control signal ELM1 may be supplied to the first input terminal 101 of the first emission stage EST11. The first emission clock signal ECK1 may be supplied to the second input terminal 102 of the first emission stages EST11, EST13, . . . . The second emission control signal ELM2 may be supplied to the first input terminal 101 of the second emission stage EST12. The second emission clock signal ECK2 may be supplied to the second input terminal 102 of the second emission stages EST12, EST14, . . .

In an embodiment, an emission operation of the pixels connected to the first emission lines EL1, EL3, . . . and an emission operation of the pixels connected to the second emission lines EL2, EL4, . . . may be alternately performed.

Referring to FIG. 9, a connection relationship between the scan driver 13b and the pixel unit 15b according to the second embodiment is shown. FIG. 9 shows four scan stages ST1 to ST4 for convenience of description. In addition, since the scan driver 13b and the pixel unit 15b of FIG. 9 are similar to the scan driver 13a and the pixel unit 15a of FIG. 6, an overlapping description is omitted.

The scan driver 13b may include first scan stages ST1, ST3, . . . connected to the first scan lines SL1, SL3, . . . , and second scan stages ST2, ST4, . . . connected to the second scan lines SL2, SL4, . . .

The first scan lines SL1, SL3, . . . may be connected to the pixels positioned in the first pixel columns among the first pixel rows of the pixel unit 15b and the pixels positioned in the second pixel columns among the second pixel rows of the pixel unit 15b. The second scan lines SL2, SL4, . . . may be connected to the pixels positioned in the first pixel columns among the second pixel rows of the pixel unit 15b and the pixels positioned in the second pixel columns among the first pixel rows of the pixel unit 15b.

In an embodiment, the first pixel rows may be odd-numbered pixel rows, the second pixel rows may be even-numbered pixel rows, the first pixel columns may be odd-numbered pixel rows, and the second pixel columns may be odd-numbered pixel rows.

For example, the first scan line SL1 may be connected to the first pixel PX11 and the third pixel PX13 of the first pixel row and the second pixel PX22 of the second pixel row. The second scan line SL2 may be connected to the first pixel PX21 and the third pixel PX23 of the second pixel row and the second pixel PX32 of the third pixel row.

Referring to FIGS. 7 and 9, the first scan start signal FLM1 may be supplied to the first input terminal 1001 of the first scan stage ST1. The first scan clock signal CK1 may be supplied to the second input terminal 1002 of the first scan stages ST1, ST3, . . . . The second scan start signal FLM2 may be supplied to the first input terminal 1001 of the second scan stage ST2. The second scan clock signal CK2 may be supplied to the second input terminal 1002 of the second scan stages ST2, ST4, . . .

In an embodiment, the scan operation of the pixels connected to the first scan lines SL1, SL3, . . . and the scan operation of the pixels connected to the second scan lines SL2, SL4, . . . may be alternately performed.

The scope of this disclosure is not limited to the content described in the detailed description of the specification, but should be defined by the claims. The meaning and scope of the claims, including all changes modifications derived from the equivalent concepts, should be considered within the scope of the disclosure.

What is claimed is:

1. A display device comprising:
a pixel unit including first pixel rows connected to first emission lines and second pixel rows connected to second emission lines, wherein the second pixel rows alternate with the first pixel rows;
an emission driver including first emission stages connected to the first emission lines and second emission stages connected to the second emission lines; and
a scan driver including first scan stages connected to the first pixel rows and second scan stages connected to the second pixel rows,
wherein one of the first emission stages is connected to a first emission start line, one of the second emission stages is connected to a second emission start line,
each of the first emission stages, except the first emission stage connected to the first emission start line, is connected to a first emission line of a previous first emission stage, and
each of the second emission stages, except the second emission stage connected to the second emission start line, is connected to a second emission line of a previous second emission stage.

2. The display device according to claim 1, wherein after the emission driver applies an emission control signal having a turn-on level to one emission line among the first emission lines and the second emission lines, the emission driver applies the emission control signal having the turn-on level to other emission lines among the first emission lines and the second emission lines, except the emission line to which the emission control signal having the turn-on level was applied.

3. The display device according to claim 1, wherein the first emission stages are connected to a first emission clock line,
the second emission stages are connected to a second emission clock line, and
pulses of a first emission clock signal applied to the first emission clock line and pulses of a second emission clock signal applied to the second emission clock line do not overlap each other.

4. The display device according to claim 3, wherein one of the first scan stages is connected to a first scan start line, one of the second scan stages is connected to a second scan start line,
each of the first scan stages, except the first scan stage connected to the first scan start line, is connected to a first scan line of a previous first scan stage, and
each of the second scan stages, except the second scan stage connected to the second scan start line, is connected to a second scan line of a previous second scan stage.

5. The display device according to claim 4, wherein the first scan stages are connected to a first scan clock line,
the second scan stages are connected to a second scan clock line, and
pulses of a first scan clock signal applied to the first scan clock line and pulses of a second scan clock signal applied to the second scan clock line do not overlap each other.

6. The display device according to claim 5, wherein the first emission clock signal and the first scan clock signal have the same waveform.

7. The display device according to claim 5, wherein the second emission clock signal and the second scan clock signal have the same waveform.

8. A display device comprising:
a pixel unit including first pixel rows and second pixel rows alternating with the first pixel rows;
an emission driver including first emission stages connected to a first emission line, which is connected to pixels positioned in first pixel columns among the first pixel rows and pixels positioned in second pixel columns among the second pixel rows, and second emission stages connected to a second emission line, which is connected to pixels positioned in the first pixel columns among the second pixel rows and pixels positioned in the second pixel columns among the first pixel rows; and
a scan driver connected to the pixel unit,
wherein one of the first emission stages is connected to a first emission start line, one of the second emission stages is connected to a second emission start line,
each of the first emission stages, except the first emission stage connected to the first emission start line, is connected to a first emission line of a previous first emission stage, and
each of the second emission stages, except the second emission stage connected to the second emission start line, is connected to a second emission line of a previous second emission stage.

9. The display device according to claim 8, wherein after the emission driver applies an emission control signal having a turn-on level to one emission line among the first emission lines and the second emission lines, the emission driver applies the emission control signal having the turn-on level to other emission lines among the first emission lines and the second emission lines to which the emission control signal having the turn-on level was applied.

10. The display device according to claim 8, wherein the first emission stages are connected to a first emission clock line,
the second emission stages are connected to a second emission clock line, and
pulses of a first emission clock signal applied to the first emission clock line and pulses of a second emission clock signal applied to the second emission clock line do not overlap each other.

11. The display device according to claim 10, wherein the scan driver includes first scan stages connected to a first scan line, which is connected to the pixels positioned in the first pixel columns among the first pixel rows and the pixels positioned in the second pixel columns among the second pixel rows, and second scan stages connected to a second scan line, which is connected to the pixels positioned in the first pixel columns among the second pixel rows and the pixels positioned in the second pixel columns among the first pixel rows.

12. The display device according to claim 11, wherein one of the first scan stages is connected to a first scan start line, one of the second scan stages is connected to a second scan start line,
each of the first scan stages, except the first scan stage connected to the first scan start line, is connected to a first scan line of a previous first scan stage, and
each of the second scan stages, except the second scan stage connected to the second scan start line, is connected to a second scan line of a previous second scan stage.

13. The display device according to claim 12, wherein the first scan stages are connected to a first scan clock line,
the second scan stages are connected to a second scan clock line, and
pulses of a first scan clock signal applied to the first scan clock line and pulses of a second scan clock signal applied to the second scan clock line do not overlap each other.

14. The display device according to claim 13, wherein the first emission clock signal and the first scan clock signal have the same waveform.

15. The display device according to claim 13, wherein the second emission clock signal and the second scan clock signal have the same waveform.

16. A display device comprising:
a pixel unit including first pixel rows connected to first emission lines and second pixel rows connected to second emission lines, wherein the second pixel rows alternate with the first pixel rows;
an emission driver including first emission stages connected to the first emission lines and second emission stages connected to the second emission lines; and
a scan driver including first scan stages connected to the first pixel rows and second scan stages connected to the second pixel rows,
wherein one of the first emission stages is connected to a first emission start line, and
wherein each of the first emission stages, except the first emission stage connected to the first emission start line, is connected to a first emission line of a previous first emission stage.

17. The display device of claim 16, wherein one of the second emission stages is connected to a second emission start line, and
wherein each of the second emission stages, except the second emission stage connected to the second emission start line, is connected to a second emission line of a previous second emission stage.
